(19) United States
(12) Patent Application Publication
(10) Pub. No.: US 2013/0120088 A1
(43) Pub. Date: May 16, 2013

(54) METAL WAVEGUIDE TO LAMINATED WAVEGUIDE TRANSITION APPARATUS AND METHODS THEREOF

(71) Applicants: Ke-Li Wu, Shatin, N.T. (HK); Xiaobo Huang, Shatin, N.T. (HK)

(72) Inventors: Ke-Li Wu, Shatin, N.T. (HK); Xiaobo Huang, Shatin, N.T. (HK)

(73) Assignee: The Chinese University of Hong Kong

(21) Appl. No.: 13/298,067

(22) Filed: Nov. 16, 2011

(51) Int. Cl. H01P 1/04; G06F 17/50; H01Q 1/38

(52) U.S. Cl. 333/254; 703/1; 343/700 MS

(57) ABSTRACT

Disclosed is a transition apparatus for transitioning wide frequency band electromagnetic waves between the metal waveguide and the laminated waveguide. The transition apparatus includes a top conductive layer, a bottom conductive layer, a conductive wall, and a transition interior. The conductive wall is formed along a substrate of the laminated waveguide and electrically connected the top conductive layer and the bottom conductive layer. The transition interior is defined by the top conductive layer, the bottom conductive layer, and the conductive wall. The conductive wall further comprises a plurality of stubs extending from an inner side of the wall into the transition interior, the plurality of stubs divide the transition interior into three or more resonator cavities for transitioning wide frequency band electromagnetic waves between the metal waveguide and the laminated waveguide.

### TECHNICAL FIELD

This application relates to metal waveguide to laminated waveguide transition and methods thereof.

### BACKGROUND

Metal waveguides and laminated waveguides are examples of transmission lines that transport electromagnetic energy. A metal waveguide is usually constructed as a metal tube in which an electromagnetic signal wave propagates along the interior of the tube by reflecting back and forth between the walls of the waveguide. A metal waveguide can be filled either with air or dielectrics and its cross-section is generally circular or rectangular.

Metal waveguides have a critical wavelength for passage of signals within. The wavelength is determined by the geometry and the size of the waveguide. Only those signals whose wavelength is shorter than the critical wavelength can propagate in the waveguide. At high microwave frequency, particularly the millimeter-wave frequency, the metal waveguide has proven to be a transmission line with minimum signal loss.

A laminated waveguide includes a dielectric substrate, a pair of main conductive layers deposited on the upper surface and the lower surface of the dielectric substrate, a plurality of through conductors such as filled via-holes extending in a thickness direction in the dielectric substrate so that the through conductors electrically connect the pair of the main conductive layers and a number of sub-conductive strip layers, which are embedded and electrically connected to the via-holes within the dielectric substrate.

U.S. Pat. No. 7,064,633 describes an apparatus and a method for transitioning electromagnetic wave between metal waveguide and laminated waveguide. The apparatus uses a pair of 2-pole resonators to yield two reflection zeros in the pass-band.

### SUMMARY OF THE APPLICATION

According to an aspect of the present application, a transition apparatus for transitioning electromagnetic waves between a metal waveguide and a laminated waveguide is provided. The transition apparatus includes: a top conductive layer; a bottom conductive layer; a conductive wall formed along a substrate of the laminated waveguide and electrically connected the top conductive layer and the bottom conductive layer; and a transition interior defined by the top conductive layer, the bottom conductive layer, and the conductive wall. The conductive wall further includes a plurality of stubs extending from an inner side of the wall into the transition interior, the plurality of stubs divide the transition interior into three or more resonator cavities for transitioning the electromagnetic waves between the metal waveguide and the laminated waveguide.

According to an aspect of the present application, a method for designing a transition apparatus for transitioning electromagnetic waves between a metal waveguide and a laminated waveguide by using simulation software is provided. The method includes: establishing an equivalent circuit model for the transition apparatus, wherein the three or more resonator cavities of the transition apparatus are equivalent to three or more inter-coupled resonators functioned as a multi-pole filter; determining coupling coefficients between the metal waveguide, the laminated waveguide and the three or more inter-coupled resonators; and obtaining dimensions of the transition apparatus by using the simulation software to analyze the equivalent circuit model with the determined coupling coefficients.

According to an aspect of the present application, an integrated antenna array is provided. The antenna array includes: an air-filled waveguide for inputting electromagnetic waves; a laminated waveguide for receiving the electromagnetic waves from the air-filled waveguide via the proposed transition apparatus; and a plurality of patch elements formed on the laminated waveguide for receiving or transmitting electromagnetic waves from the laminated waveguide.

### BRIEF DESCRIPTION OF THE DRAWINGS

FIG. 1 is a schematic cut-away perspective view of a waveguide apparatus according to an embodiment of the present application.

FIG. 2 is an exploded perspective view of a waveguide apparatus as shown in FIG. 1 according to an embodiment of the present application.

FIG. 3 is a top view of a sub-conductive layer of the substrate of the laminated waveguide according to one embodiment of the present application.

FIG. 4a shows a top view of a transition without stubs inside, FIG. 4b and FIG. 4c illustrate the electric field of TE₁₀ modes at the reference planes a-a′ and b-b′ as shown in FIG. 4, respectively.

FIGS. 5a-5g illustrate the electric field of TE₁₀ modes at the reference planes of A-A′ to G-G′ as shown in FIG. 3, respectively.

FIG. 6 is an equivalent circuit model of the laminated waveguide shown in FIG. 1.

FIGS. 7(a), 7(b) and 7(c) illustrate the electric field distribution of resonant modes for the three resonators, separately.

FIG. 8 is a schematic view showing the variables of the transition according to an embodiment of the present application.

FIG. 9 illustrates an electric field distribution of a transition at 36.3 GHz according to one embodiment of the present application.

FIG. 10 is a graph showing the scattering parameters of the EM and circuit models of a single transition according to one embodiment of the present application.

FIG. 11 is a graph showing simulated and measured reflection performance of an implementation of transition according to one embodiment of the present application.

FIG. 12 illustrates an antenna using the transition according to one embodiment of the present application.

FIGS. 13a and 13b are graphs showing the measured and simulated reflection coefficients and the E-plane pattern of the array at 36 GHz, respectively.

### DETAILED DESCRIPTION OF THE APPLICATION

The present application and various advantages thereof will be described with reference to exemplary embodiments in conjunction with the drawings. The description and drawings are for the purpose of illustration and not limitation. In each of the drawings like reference numerals refer to like features.

In many communication systems operating in a millimeter wave frequency band, such as broadband communication systems, vehicular anti-collision radars and microwave image systems, in order to minimize attenuation and maintain high efficiency and sensitivity, a waveguide transmission line is used as the major means for distributing and collecting the high frequency signal among various modules.

Metal waveguides and laminated waveguides are examples of transmission lines that transport electromagnetic energy.

The metal waveguide is usually constructed as a metal tube in which an electromagnetic signal wave propagates along the interior of the tube by reflecting back and forth between the walls of the waveguide.

The concept of laminated waveguide was proposed for implementing a waveguide circuit by a planar laminated substrate. The cross-sectional size of the laminated waveguide can be reduced by using a high dielectric constant substrate. In an example, a circuit system integrated with a laminated waveguide can be produced by a laminating technology, such as Low Temperature Co-fired Ceramics (LTCC) technology.

In practice, an integrated laminated waveguide system may need to be interfaced with an external system whose interface port is a mental waveguide, such as an air-filled waveguide.

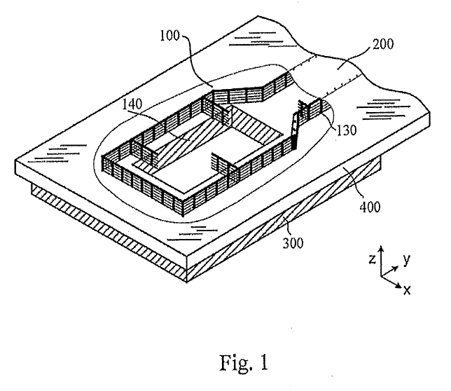

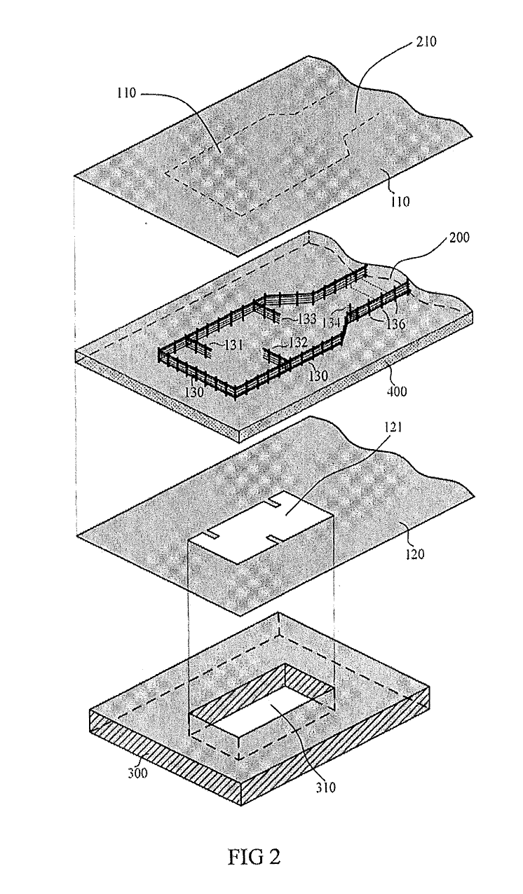

FIG. 1 illustrates a perspective cut-away view of a transition apparatus 100 for transitioning electromagnetic waves between a laminated waveguide 200 and a metal waveguide 300 according to one embodiment of the present application. FIG. 2 is an exploded perspective view of a waveguide apparatus as shown in FIG. 1 according to an embodiment of the present application.

As shown in FIG. 1 and FIG. 2, the transition apparatus 100 includes a top conductive layer 110, a bottom conductive layer 120, a conductive wall 130, and a transition interior 140. The transition interior 140 is an interior compartment defined by the top conductive layer 110, the bottom conductive layer 120, and the conductive wall 130. The conductive wall 130 can electrically connect the top conductive layer 110 and the bottom conductive layer 120. The conductive wall 130 is formed along a substrate 400 disposed between the top conductive layer 110 and the bottom conductive layer 120. As shown in FIGS. 1 and 2, the conductive wall 130 includes a plurality of stubs 131-134 extending from an inner side of the wall into the transition interior 140. The plurality of stubs 131-134 divide the transition interior into three or more resonator cavities for transitioning the electromagnetic waves between the laminated waveguide 200 and the metal waveguide 300. The resonator cavities are cavities configured to make the received signals (electromagnetic waves) resonate therein such that there are a plurality of reflection zeros within a pass-band of the resonated signals. The number of the reflection zero is equal to the number of the cavities. The transition apparatus with the resonator cavities can be used to bridge the dominant TE₁₀ modes in the air-filled waveguide and the laminated waveguide.

According to an embodiment, the metal waveguide 300 is an air-filled waveguide connected to the bottom conductive layer 120 of the transition apparatus. In an embodiment, the air-filled waveguide 300 is a conductive tube having an inside aperture 310. For example, the air-filled waveguide 300 is a rectangular waveguide 300 with a rectangular insider aperture 310. As shown in FIG. 2, the bottom conductive layer 120 of the transition apparatus includes an aperture 121. The aperture 121 of the bottom conductive layer 120 is aligned with and opened toward the inside aperture 310 of the air-filled waveguide 300. The aperture 121 can be functioned as an input/output port for receiving/transmitting electromagnetic waves from/to the air-filled waveguide 300.

According to an embodiment, the laminated waveguide 200 is a low-temperature co-fired ceramics (LTCC) laminated waveguide.

In an embodiment, the laminated waveguide 200 includes a first conductive layer 210, a second conductive layer 220, and the substrate 400. As shown in FIG. 2, the first conductive layer 210 shares the same flat with the top conductive layer 110 of the transition apparatus 100. The second conductive layer 220 shares the same flat with the bottom conductive layer 120 of the transition apparatus 100. The substrate 400 includes a plurality of dielectric layers, and a plurality of sub-conductive layers deposited between the dielectric layers. The number of dielectric layers of the substrate 400 is determined by the size of the laminated waveguide and thickness of each dielectric layer. In an embodiment, the laminated waveguide is stretched along a direction of the wider edge of the rectangular air-filled wavegide 300 from the vicinity of the narrower edge of the waveguide.

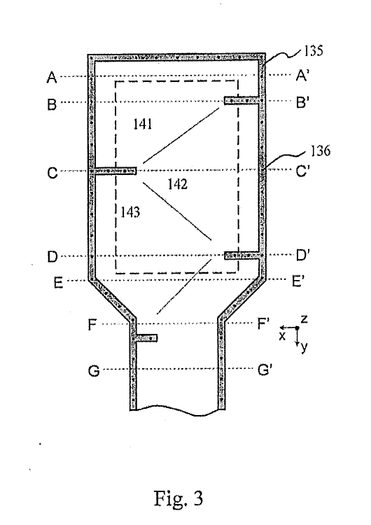

According to an embodiment, the conductive wall 130 is formed along the substrate 400 of the laminated waveguide 200. The wall 130 includes a plurality of conductive strips 135, and a plurality of via-holes 136. Each of the conductive strips 135 is formed in each of the sub-conductive layers of the laminated waveguide. FIG. 3 is a top view of a sub-conductive layer of the substrate showing one of the conductive strips 135. The plurality of via-holes 136 are formed extending in a thickness direction of the substrate to electrically connect the top conductive layer, the bottom conductive layer, and the conductive strips formed on the sub-conductive layers.

According to an embodiment, as shown in FIGS. 1-3, the transition interior defined by the conductive wall 130 has a shape of rectangular. Four stubs 131-134 are formed, perpendicularly extending from the wall 130 into the transition interior 140. According to the embodiment, the stubs 131-134 divide the interior 140 into the three resonator cavities 141, 142 and 143 as shown in FIG. 3. The three resonators are excited, for example, in phase with electromagnetic waves via the input aperture 121 from the air-filled waveguide 300. In addition, the three resonators are in-line coupled through physical gaps formed between each pair of those stubs 131-134.

In an embodiment, positions of the four stubs 131-134 are designed so that the three inter-coupled resonator cavities are three analogously triangular-shaped resonators which can be used to construct a three-pole band pass filter. For example, the four stubs 131-134 are connected to two opposite side of the wall 130 alternatively. In an embodiment, the length of each of the four stubs can be designed corresponding to the required mutual coupling between two resonant cavities.

In an embodiment, the interval space between the via-holes 136 of the side wall 130 can be determined by the required working frequency.

According to an embodiment, the electromagnetic energy is transmitted between the laminated waveguide 200 and the metal waveguide 300 via the three resonator cavities 141, 142 and 143 of the interior 140.

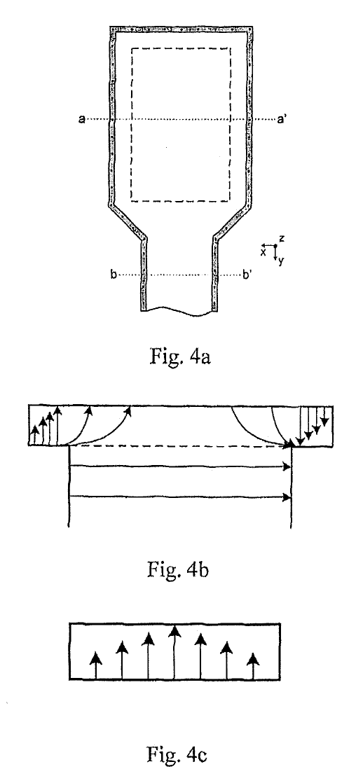

Hereinafter, the working mechanism of the transition will be explained by comparing a transition without stubs inside as shown in FIG. 4a with a transition with four stubs inside as shown in FIG. 3.

FIG. 4a shows a top view of a transition without stubs inside for transitioning electromagnetic waves between an air-filled waveguide and a laminated waveguide. FIG. 4b and FIG. 4c illustrate the electric field of TE₁₀ modes at the reference planes a-a′ and b-b′ as shown in FIG. 4a, respectively. It is seen that the field pattern on plane a-a′ as shown in FIG. 4b is an odd function whereas that on b-b′ as shown in FIG. 4c is an even function with respect to the center line of the laminated waveguide. Therefore, these two modes are orthogonal to each other. That means there is no coupling between the air-filled waveguide and the laminated waveguide by using the transition without stubs.

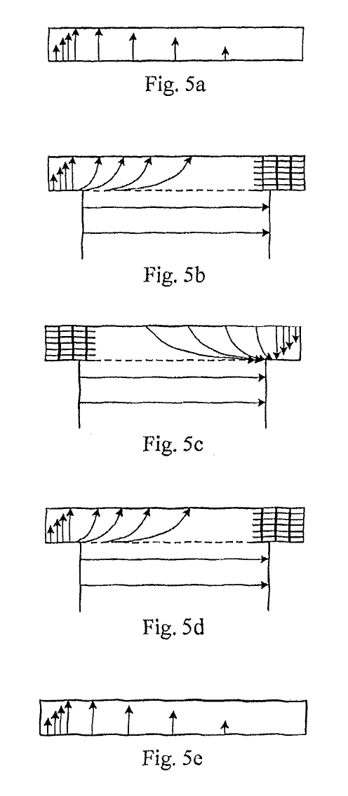

FIGS. 5a-5g illustrate the electric field of TE₁₀ modes at the reference planes of A-A′ to G-G′ as shown in FIG. 3, respectively. It can be seen that the four stubs 131-134 change the electric field distribution in the interior of the transition and create three quasi-half-wavelength resonators in the substrate partially bounded by the interface between the air and the high dielectric constant LTCC substrate. It can be seen that the transition with 4 stubs inside is capable of transitioning electromagnetic waves between a metal waveguide and a laminated waveguide.

According to another embodiment, a method for designing a transition apparatus by using simulation software is provided. The method comprises establishing an equivalent circuit model for the transition apparatus; determining coupling coefficients between the metal waveguide, the laminated waveguide and the three resonators; and obtaining dimensions of the transition apparatus by using circuit simulation software to determine the required coupling coefficients.

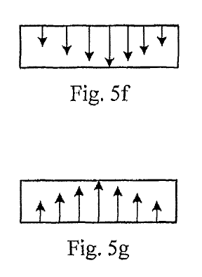

In an embodiment, an equivalent circuit model is established as shown in FIG. 6. In the equivalent circuit model, the three transition cavities can be regarded as a three-pole filter. Thus, the concept of filter design can be employed to explain the working mechanism and design methods of the transition. In FIG. 6, LC Loops LC-1, LC-2 and LC-3 represent the resonator cavities 141, 142 and 143 of the interior 140, respectively. The coupling coefficients M₀₁, M₀₂ and M₀₃ denote couplings between the air-filled waveguide 300 and the three resonator cavities 141, 142 and 143, respectively. The coupling coefficient M₃₄ denotes the coupling between the laminated waveguide 200 and resonator cavity 143. The coupling coefficient M₁₂ denotes the mutual coupling between the resonator 141 and the resonator 142. The coupling coefficient M₂₃ denotes the mutual coupling between the resonator 142 and the resonator 143.

The coupling coefficients of M₀₁, M₀₂, M₀₃, M₁₂, M₂₃ and M₃₄ can be pre-determined or pre-designed according to the practical requirement of the three-pole filter, for example, the targeted return loss.

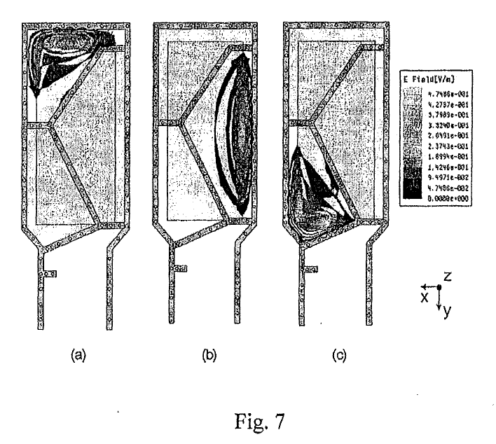

Then, the dimensions of the transition apparatus can be obtained by using the simulation software to analyze the equivalent circuit model with the determined coupling coefficients. The dimensions of the transition apparatus include the width w of the wall, the length l₁ and l₂ of the wall 130; the position t₁, t₂, t₃ and t₄ of the stubs 133; the length s₁, s₂, s₃ and s₄ and the width c of the stubs 133; the width b, the length a and the position t₀ and s₀ of the transition interior 140; the diameter d of each of the via-holes 136 and the distance e between two adjacent via-holes 136. The related dimensional variables of the transition are given in FIG. 8.

According to an embodiment, the method for designing a transition apparatus by using simulation software further include precisely turning the dimensions of the three resonators to optimize a simulation result of the software.

Hereinafter, we take a transition working at 36.3 GHz as an example to illustrate the design procedure of the transition. In an embodiment, an electromagnetic simulation software may be used for simulating the physical structure. A 3 mm long air-filled waveguide and a section of 2.5 mm long laminated waveguide are incorporated in the electromagnetic model. The substrate tape is with manufacturer specified dielectric constant of 6.1 and loss tangent of 0.002. The thickness of each layer is 0.11 mm and the laminated waveguide occupies 6 layers. The three inter-coupled resonators in FIG. 2 are constructed by analogously triangular laminated cavities. The resonant modes in the cavities are excited by the TE₁₀ mode in phase at the air-filled waveguide. The eigen mode solver of an electromagnetic software can be used to obtain the initial dimensions of each resonator. For example, High Frequency Structure Simulator (HFSS) can be used to analyze and obtain the dimensions of each resonator.

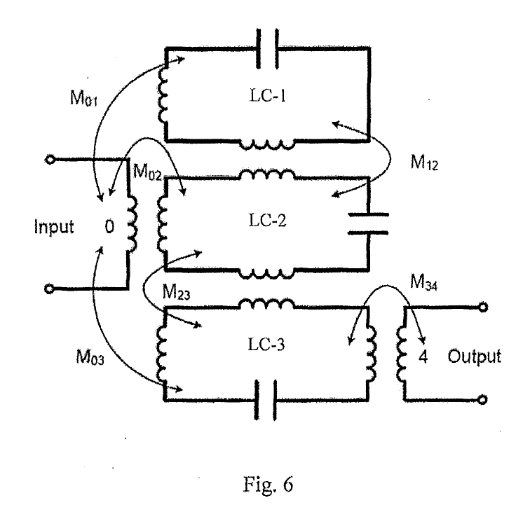

FIGS. 7(a), 7(b) and 7(c) show the electric field distribution of resonant modes for the three resonators separately. Due to the high contrast of dielectric constants of the air in the interior compartment and that of the substrate, even though there is a large aperture on the bottom plane of the substrate, a distinct resonate mode can be established to confine the electromagnetic field in each cavity divided in the interior compartment. The coupling coefficients M₀₁, M₀₂ and M₀₃ are mainly controlled by the position of the input aperture, while the coupling coefficients M₁₂, M₂₃ and M₃₄ vary with the length of the four stubs.

With the coupled resonator circuit model representation shown in FIG. 6, the corresponding coupling coefficients for the desired pass-band performance can be obtained by a classical filter synthesis procedure. For example, for 20 dB return loss and 3 GHz bandwidth at 36.3 GHz a set of appropriate coupling coefficients are M₀₁=0.6651, M₀₂=−0.4779, M₀₃=0.7774, M₁₁=−0.8596, M₁₂=−0.7724, M₂₂=0.8661, M₂₃=0.5585, M₃₃=−0.1556 and M₃₄=1.1233. The transmission zeros prescribed are located at −1.6 and 1.25 on the imaginary axis in the low-pass prototype. Although the center frequency and bandwidth used in circuit model synthesis according to the embodiment are 36.3 GHz and 3 GHz, respectively, the same coupling matrix can be scaled to other frequency and bandwidth. The nonzero self-coupling Mᵢᵢ means that the three resonators do not resonate at the same frequency. The frequency offset is proportional to the self-coupling value.

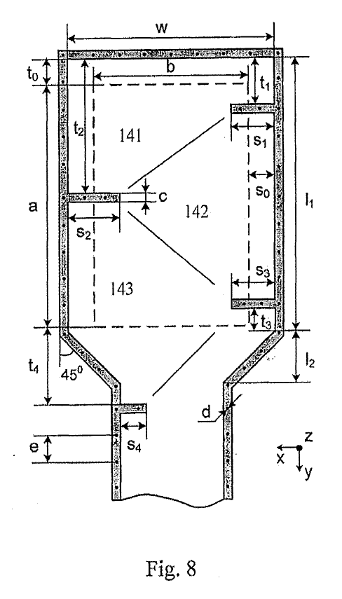

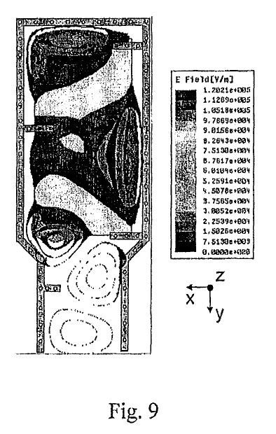

The detailed dimensions of an optimized transition are given in Table I and the electric field distribution of the designed transition at 36.3 GHz is shown in FIG. 9. The simulated frequency responses of the EM model and that of the equivalent circuit model are superimposed in FIG. 10.

TABLE 1
Dimensions of the Single Transition Design Example

| Variables | Size (mm) | Variables | Size (mm) | Variables | Size (mm) |
|---|---|---|---|---|---|
| a | 7.11 | l₁ | 7.72 | s₄ | 0.60 |
| b | 3.56 | l₂ | 0.78 | t₀ | 0.51 |
| c | 0.24 | s₀ | 0.43 | t₁ | 0.64 |
| d | 0.17 | s₁ | 1.10 | t₂ | 3.64 |
| e | 0.60 | s₂ | 1.10 | t₃ | 0.71 |
| w | 4.41 | s₃ | 1.20 | t₄ | 1.82 |

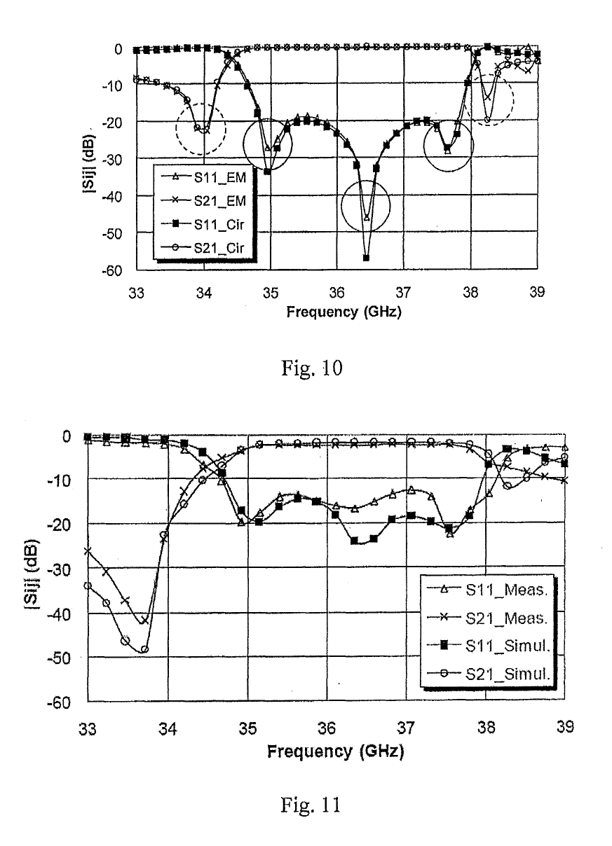

A back-to-back prototype module of the proposed transition on an LTCC substrate is fabricated and tested. The length of the laminated waveguide between two transitions is 14.4 mm. The measured and the EM simulated S-parameters are shown in FIG. 11. The measured in band insertion loss of the back-to-back module is better than 1.3 dB from 34.8-37.8 GHz with a return loss better than 13 dB. As the simulated insertion loss of the 14.4 mm long laminated waveguide is about 0.6 dB, it is derived that the measured insertion loss of a single transition will be less than 0.35 dB from 34.8 to 37.8 GHz.

### Exemplary Application

The transition for transitioning electromagnetic waves between a metal waveguide and a laminated waveguide disclosed in one or more embodiments can be used in various applications, such as antenna arrays, microwave front end modules and so on.

Here, we take an integrated antenna array as an example to describe the application of the transition. For example, a prototype of a 4×4 Ka band LTCC based right-handed circularly polarized antenna array 1200 is proposed.

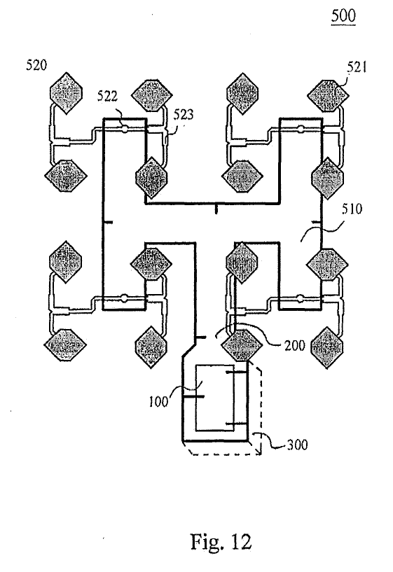

FIG. 12 illustrates an integrated antenna array 500 with the transition apparatus according to an embodiment of the application. The antenna array 500 includes a transition apparatus 100; an air-filled waveguide 300 for inputting electromagnetic waves; a laminated waveguide 200 for receiving the electromagnetic waves from the air-filled waveguide via the transition apparatus 100; and a plurality of patch elements 521 formed on the laminated waveguide for receiving or transmitting electromagnetic waves from the laminated waveguide 200.

The transition apparatus 100 can be any transition apparatus as described above, to realize the transition of the electromagnetic waves between the metal waveguide 300 and the laminated waveguide 200.

The main trunk 510 of the array feeding network is constructed by laminated waveguide and the proposed transition is integrated in the substrate. The square radiating patch element with a pair of opposite corner-cuts is chosen to create circularly polarized waves. The sequential rotation of array elements is adopted for increasing the axial ratio (AR) bandwidth. The electromagnetically proximity coupled microstrip feeding network is employed in each 2×2 sub-array 520.

Underneath the ground plane of the microstrip antenna array, a 6-layer low loss laminated waveguide feed network sketched in FIG. 12 is created to form the main trunk of the feeding network of the 4×4 array. Here an integrated laminated waveguide-to-microstrip line T-junction 523 is employed to extend the laminated waveguide feeding network to each radiating element through a short section 522 of microstrip line.

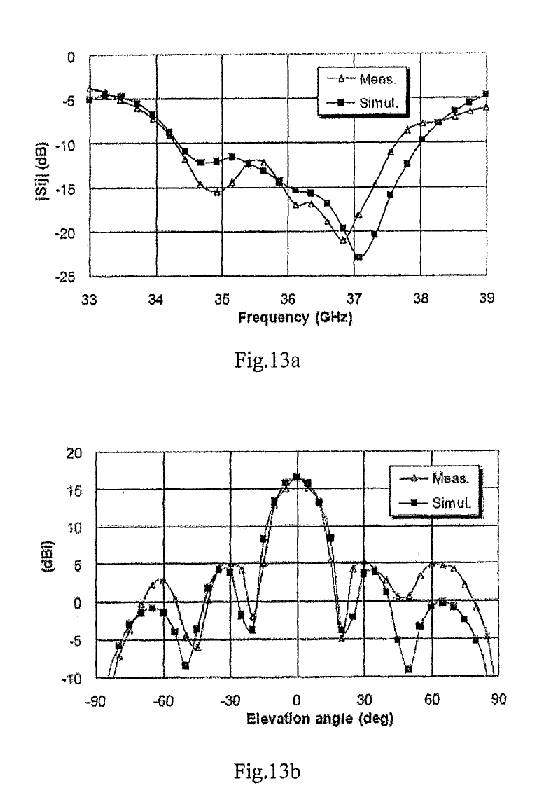

The return loss of the antenna array is measured by using an R&S ZVA67 vector network analyzer. A thru-reflect-line (TRL) calibration is conducted for de-embedding. Considering those inevitable manufacturing error, very good agreement between the measured and the simulated return loss of the antenna array can be observed in FIG. 13a. The antenna array exhibits an impedance matching bandwidth of 3.3 GHz with return loss of better than 12 dB. The peak gain of the measured and the simulated gains of the antenna array with the transition at 36 GHz are 16.47 dBi and 16.52 dBi, respectively. For comparison purpose, it has to be mentioned that the simulated peak gain of the same antenna array with microstrip line feeding network is 15.72 dBi, assuming that 0.35 dB insertion loss from an SMA connector to the microstrip line transition has been considered. It means that the array with the laminated waveguide feeding network can provide 0.8 dB more gain than that if it is fed by a microstrip line network. The measured and the simulated E-plane radiation pattern at 36 GHz is provided in FIG. 13b, demonstrating that an integrated antenna array with the proposed waveguide device can be a good candidate for high performance and low cost mm-wave antenna array.

The transition provides many attractive features with excellent performance in terms of its compact size, wide bandwidth and convenience to be integrated with other planar circuits. Such compact integrated transition enables the flexibility of mixed type of feeding network and possibility of integrating other waveguide sub-circuits for a low transmission loss and less parasitic radiation mm-wave system on package module.

While we have hereinbefore described the embodiments of this application, it is understood that our basic constructions can be altered to provide other embodiments which utilize the processes and compositions of this application. Consequently, it will be appreciated that the scope of this application is to be defined by the claims appended hereto rather than by the specific embodiments which have been presented hereinbefore by way of examples.

What is claimed is:

1. A transition apparatus for transitioning electromagnetic waves between a metal waveguide and a laminated waveguide, comprising:
a top conductive layer;
a bottom conductive layer;
a conductive wall formed along a substrate of the laminated waveguide and electrically connected the top conductive layer and the bottom conductive layer; and
a transition interior defined by the top conductive layer, the bottom conductive layer, and the conductive wall,
wherein the conductive wall further comprises a plurality of stubs extending from an inner side of the wall into the transition interior, the plurality of stubs divide the transition interior into three or more resonator cavities for transitioning the electromagnetic waves between the metal waveguide and the laminated waveguide.

2. The apparatus according to claim 1, wherein the plurality of stubs are four stubs perpendicularly extending from the inner side of the wall into the transition interior, and the four stubs divide the transition interior into three inter-coupled resonator cavities.

3. The apparatus according to claim 2, wherein a cross section of the transition interior defined by the conductive wall has a rectangular shape, and the four stubs are connected to two opposite side of the wall alternatively so that the three resonator cavities are three analogously triangular resonant cavities.

4. The apparatus according to claim 2, wherein a length of each of the four stubs is designed corresponding to the mutual coupling between the metal waveguide, the laminated waveguide and the three resonant cavities.

5. The apparatus according to claim 2, wherein the three resonator cavities are functioned as a three-pole filter.

6. The apparatus according to claim 1, wherein the laminated waveguide comprises:
a first conductive layer;
a second conductive layer; and
the substrate,
wherein the first conductive layer shares a same flat with the top conductive layer of the transition apparatus, the second conductive layer shares a same flat with the bottom conductive layer of the transition apparatus, the substrate comprises a plurality of dielectric layers, and a plurality of sub-conductive layers deposited between the dielectric layers.

7. The apparatus according to claim 6, wherein the conductive wall formed along the substrate of the laminated waveguide comprises:
a plurality of conductive strips, each conductive strip formed in each of the sub-conductive layers of the laminated waveguide; and
a plurality of via-holes extending in a thickness direction of the substrate to electrically connect the top conductive layer, the bottom conductive layer, and the plurality of conductive lines.

8. The apparatus according to claim 1, wherein the laminated waveguide is a low-temperature co-fired ceramics (LTCC) laminated waveguide.

9. The apparatus according to claim 1, wherein the metal waveguide is an air-filled waveguide connected to the bottom conductive layer of the transition apparatus.

10. The apparatus according to claim 9, wherein the air-filled waveguide comprises an inside aperture, the bottom conductive layer comprises an aperture, and the aperture of the bottom conductive layer is aligned with and opened toward the inside aperture of the air-filled waveguide.

11. The apparatus according to claim 1, wherein the metal waveguide and the laminated waveguide are configured for propagating electromagnetic waves of at least 20 GHz.

12. The apparatus according to claim 1, wherein the three or more resonator cavities are excited by the TE₁₀ mode in phase at the metal waveguide.

13. A method for designing a transition apparatus of claim 1 for transitioning electromagnetic waves between a metal waveguide and a laminated waveguide by using simulation software, comprising:
establishing an equivalent circuit model for the transition apparatus, wherein the three or more resonator cavities of the transition apparatus are equivalent to three or more inter-coupled resonators functioned as a multi-pole filter;
determining coupling coefficients between the metal waveguide, the laminated waveguide and the three or more inter-coupled resonators; and
obtaining dimensions of the transition apparatus by using the simulation software to analyze the equivalent circuit model with the determined coupling coefficients.

14. The method according to claim 13, wherein the number of the resonator cavities of the transition apparatus is determined by the working frequency of the electromagnetic waves transmitted between the metal waveguide and the laminated waveguide.

15. The method according to claim 13, wherein the number of the resonator cavities is three and the three resonator cavities are equivalent to three inter-coupled resonators functioned as a three-pole filter.

16. The method according to claim 13, wherein the dimensions of each of the three or more resonators are determined by using an eigen mode solver of the electromagnetic software.

17. The method according to claim 13, wherein the coupling coefficients are determined corresponding to the multi-pole filter established by the equivalent circuit model.

18. The method according to claim 13, wherein the three or more resonator cavities are excited by the TE₁₀ mode in phase at the metal waveguide.

19. The method according to claim 13, further comprising:
the dimensions of each of the three or more resonators are precisely turned to optimize a simulation result simulated by using the electromagnetic software.

20. An integrated antenna array, comprising:
an air-filled waveguide for inputting electromagnetic waves;
a laminated waveguide for receiving the electromagnetic waves from the air-filled waveguide via the transition apparatus of claim 1; and
a plurality of patch elements formed on the laminated waveguide for receiving or transmitting electromagnetic waves from the laminated waveguide.

21. The integrated antenna array of claim 20, wherein the plurality of patch elements are formed as four groups of 2*2 radiating sub-array elements.

22. The integrated antenna array of claim 21, wherein the 2*2 radiating sub-array elements have a pair of opposite corner-cuts to create circularly polarized waves.

23. The integrated antenna array of claim 20, wherein an integrated laminated waveguide to microstrip line T-junction is used to connect the laminated waveguide to each radiating element.
